(19) United States
(12) Patent Application Publication
(10) Pub. No.: US 2008/0211995 A1
(43) Pub. Date: Sep. 4, 2008

(54) Display Apparatus Using Microlens

(76) Inventors: Jin-Wan Jeon, Daejeon (KR); Joo-Hyung Lee, Daejeon (KR); Dae-Hyun Kim, Daejeon (KR); Koeng Su Lim, Daejeon (KR); Jun-Eo Yoon, Daejeon (KR)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 12/090,229

(22) PCT Filed: Mar. 20, 2007
(86) PCT No.: PCT/KR2007/001353

§ 371 Date: Apr. 14, 2008

(30) Foreign Application Priority Data
Apr. 12, 2006 (KR) 10 2006 0033214

(51) Int. Cl. G02B 27/18; G02F 1/1335

(52) U.S. Cl. 349/95; 359/259

(57) ABSTRACT

Provided is a display apparatus using a micromirror or an image display device. The display apparatus is designed to eliminate dark regions, usually formed by pixel partitions or black matrixes, display a high-quality image by increasing light usage efficiency, and improve the power consumption. A display apparatus using a microlens includes a micromirror array, a substrate, and a microlens array. The micromirror array includes a plurality of micromirrors arranged to reflect incident light rays from a light source. The substrate supports the micromirror array. The microlens array includes a plurality of microlenses disposed between the light source and the micromirror array to condense the incident light rays from the light source upon the micromirror array and correct a traveling path of reflected light rays from the micromirror array.

### TECHNICAL FIELD

The present invention relates to a display apparatus, more particularly, to a display apparatus using a microlens implemented in a projector, a scanner, a liquid crystal display apparatus, or an electroluminescent display (ELD) apparatus.

### BACKGROUND ART

A progressive advancement in information technology has increasingly demanded various types of display apparatuses. In an attempt to meet this demand, many researchers have developed various types of flat display apparatuses such as liquid crystal displays (LCDs), plasma display panels (PDPs), and electroluminescent displays (ELDs), and some of these display apparatuses are applied as display apparatuses in various types of equipment.

For instance, the display apparatuses are applied to computers, cellular phones, and apparatuses that display a desired image on a screen using illumination such as projection equipment (projector), scanning equipment (scanner), bar code equipment.

Hereinafter, conventional display apparatuses using various modes will be described in detail.

FIG. 1 illustrates a simplified view of a projection type display apparatus using a conventional micromirror array. With reference to FIG. 1, the projection type display apparatus using the conventional micromirror array, which is one exemplary display apparatus, will be described in detail.

The projection type display apparatus using the micromirror array includes a light source (not shown), an incident lens 14, a micromirror array 11, a substrate 10, and a projection lens 15. Rays of light beamed from the light source impinge on the incident lens 14. The micromirror array 11 includes a plurality of micromirrors in a matrix form. The substrate 10 supports the micromirror array 11. The projection lens 15 projects rays of reflection light 13 from the micromirror array 11 on a screen.

On the basis of this configuration, the conventional projection type display apparatus reflects rays of incident light 12 from the light source at a certain angle through the micromirror array 11, and projects the reflected light rays on the screen through the projection lens 15.

The individual micromirrors of the micromirror array 11 are arranged to be rotatable with respect to the substrate 10. Thus, according to rotational angles, the micromirrors can reflect the incident light 12 in different directions. A direction of the reflection leads the micromirror array 11 to be divided into a bright state in which an image is displayed and a dark state in which an image is not displayed. Adjusting a sustaining time of these states allows displaying of an image.

The rays of the incident light 12 from the incident lens 14 impinge on the entire micromirror array 11. However, the rays of the incident light 12 impinging on spaces d between the micromirrors are not reflected, and thus, a net shaped dark region is more likely to appear in an image. Also, in the micromirrors manufactured by the Texas Instruments incorporated and exclusively used in current technical fields, a certain opening is formed in each of the micromirrors to support the respective mirror plates. However, these openings are also displayed as a dark region, thereby reducing the brightness of an image and deteriorating the quality of an image.

FIG. 2 illustrates a simplified view of a conventional scanning type display apparatus.

As illustrated, in the display apparatus using the conventional scanning mode, rays of incident light 22 passing through a first lens 24 from a light source are reflected at a certain angle by a scanning micromirror 21. The reflected rays of light are projected on a screen through a second lens 25. The scanning micromirror 21 is arranged to be rotatable over a substrate 20, and a rotational angle of the scanning micromirror 21 generally determines a projection position of an image. The scanning micromirror 21 rotates at a fast speed, so as to scan an image on a screen, and as a result, an image is entirely displayed.

This operational principle is often applied not only to the scanning type display apparatus but also to a scanner and a bar-code reader. However, the rotation speed of the scanning micromirror 21 needs to be high to display a high-quality image.

FIG. 3 illustrates a conventional LCD. The conventional LCD is a display apparatus that projects light using liquid crystals.

A backlight unit 30 is disposed as a light source at the back side, and a liquid crystal panel 32 where a plurality of unit pixels 32a are arranged is disposed at the front side of the backlight unit 30. Rays of light 31 originated from the backlight unit 30 are projected or shielded to display a desired image.

The liquid crystal panel 32 applies an electric field to the unit pixels 32a to change an arrangement of liquid crystals that compose the unit pixels 32a. As a result of this change, a desired image can be displayed according to an amount of light projected on the liquid crystal panel 32. Black matrixes 32b are disposed between the unit pixels 32a to distinguish the unit pixels 32a or colors from each other.

However, light transmission usually does not occur in a region ‘A’ where the black matrixes 32b are disposed, and this region ‘A’ appears dark in an image. As a result, brightness of an image is likely to decrease, and the quality of an image may also be deteriorated.

FIG. 4 illustrates a conventional self-luminous display apparatus. In particular, FIG. 4 illustrates an optical system of a display apparatus that does not need an additional light source due to the self-luminescence. Organic light emitting diodes (OLEDs), plasma display panels (PDPs), field emission displays (FEDs), electroluminescent displays (ELDs), and luminescent diodes (LEDs) are examples of such self-luminous display apparatuses.

The conventional self-luminous display apparatus displays an image using light beamed from unit pixels 41, which are arranged to have spaces 42 therebetween over a substrate 40 to distinguish the unit pixels 41 from each other.

As similar to the conventional self-luminous display apparatus illustrated in FIG. 3, an image is not displayed in the spaces 42 between the unit pixels 41, rather being displayed as a dark region. Thus, brightness of an image may be reduced, and the quality of an image may also be deteriorated.

As described above, each of the conventional display apparatuses needs to be improved in efficiency of using a light source. Also, elimination of dark regions appearing between the unit pixels (i.e., spaces between the unit pixels) is also necessary to improve the brightness and quality of an image.

### DISCLOSURE OF INVENTION

### Technical Problem

Embodiments of the present invention are directed toward providing a display apparatus using a microlens improved in light usage efficiency, image quality, and power consumption by eliminating generation of spaces between pixels (e.g., pixel partitions or black matrixes), which usually appear dark when an image is displayed using a display apparatus using a micromirror or an image display device.

Embodiments of the present invention are not limited to the above mentioned technical effects, and other effects that are not mentioned above would be clearly understood by those skilled in the art based on the following disclosure.

### Technical Solution

The present invention has been made in an effort to provide a display apparatus using a microlens. The display apparatus comprises a micromirror array including a plurality of micromirrors arranged to reflect incident light rays from a light source, a substrate supporting the micromirror array, and a microlens array including a plurality of microlenses disposed between the light source and the micromirror array to condense the incident light rays from the light source upon the micromirror array and correct a traveling path of reflected light rays from the micromirror array.

In one embodiment, the micromirrors each are disposed to be rotatable over the substrate.

In one embodiment, the incident light rays passing through the microlens array are condensed upon reflection surfaces of the micromirrors.

In one embodiment, the microlenses of the microlens array are disposed adjacent to each other.

Another embodiment of the present invention provides a display apparatus using a microlens. The display apparatus comprises a scanning micromirror reflecting incident light rays from a light source, a substrate supporting the scanning micromirror, a first microlens disposed between the light source and the scanning micromirror to condense the incident light rays from the light source upon a reflection surface of the scanning micromirror, and a second microlens disposed in a path of reflected light rays from the scanning micromirror to correct a traveling path of the reflected light rays.

According to the other embodiment, the scanning micromirror is disposed to be rotatable over the substrate.

According to the other embodiment, the first microlens and the second microlens each include an array of microlenses. The incident light rays are divided into unit blocks according to the number of the microlenses of the first microlens and directed towards the scanning micromirror.

According to the other embodiment, the first microlens and the second microlens each include an array of microlenses, and the scanning micromirror includes an array of scanning micromirrors.

According to the other embodiment, the incident light rays passing through the first microlens are divided into unit blocks according to the number of the microlenses of the first microlens, and the divided incident light rays are condensed upon the respective scanning micromirrors.

Another embodiment of the present invention provides a display apparatus using a microlens. The display apparatus comprises a scanning micromirror reflecting incident light rays from a light source, a substrate supporting the scanning micromirror, a first Fresnel lens disposed between the light source and the scanning micromirror to condense the incident light rays from the light source upon a reflection surface of the scanning micromirror, and a second Fresnel lens disposed in a path of reflected light rays from the scanning micromirror to correct a traveling path of the reflected light rays.

According to the other embodiment, the scanning micromirror is disposed to be rotatable over the substrate.

Another embodiment of the present invention provides a display apparatus using a microlens. The display apparatus comprises a liquid crystal panel including a plurality of unit pixels arranged in a matrix form to display an image through transmitting or shielding incident light rays from a light source, a first microlens array including a plurality of microlenses disposed between the light source and the liquid crystal panel to condense the incident light rays from the light source upon the unit pixels, and a second microlens array including a plurality of microlenses disposed in a path of projected light rays from the liquid crystal panel to correct a traveling path of the projected light rays from the unit pixels.

According to the other embodiment, the unit pixels of the liquid crystal panel are spaced apart from each other for isolation of the unit pixels.

Another embodiment of the present invention provides a display panel using a microlens. The display apparatus comprises a display panel including a plurality of unit pixels emitting rays of light on a substrate, and a microlens array including a plurality of microlenses formed in a path of the rays of the light emitted from the display panel to correct a traveling path of the emitted light rays.

According to the other embodiment, the unit pixels of the display panel are spaced apart from each other for isolation.

Details of other embodiments are provided in the following description of the invention and drawings. Various advantages, features and methods of achieving such advantages and features will become apparent with reference to the accompanying drawings and the following description of the embodiments. However, the present invention may be embodied in many different forms and should not be construed as being limited to the embodiments set forth herein; rather, these embodiments are provided so that this disclosure will be thorough and complete, and will fully convey the concept of the present invention to those skilled in the art. The spirit and scope of the present invention is defined by the accompanying claims.

### Advantageous Effects

On the basis of variously embodied configurations of the present invention, the display apparatus using one or more than one microlens can display an image that is much soft and bright than the conventional display apparatus by eliminating spaces regions between unit pixels in which no light may not be used or an image may not be displayed because of the isolation of the unit pixels and the use of color filters in the conventional display apparatus using various modes.

Also, incident light rays are condensed on incident and emission sides of light, and a path of emitted light rays is corrected to the original light path. Thus, light efficiency can be improved, and this improved efficiency allows the reduction in power consumption and simultaneously displaying of a high-resolution image.

### BRIEF DESCRIPTION OF THE DRAWINGS

FIG. 1 illustrates a simplified view of a conventional projection type display apparatus using a micromirror array.

FIG. 2 illustrates a simplified view of a conventional scanning type display apparatus.

FIG. 3 illustrates a simplified view of a conventional liquid crystal display (LCD).

FIG. 4 illustrates a simplified view of a conventional self-luminous display apparatus.

FIG. 5 illustrates a display apparatus according to a first embodiment of the present invention.

FIG. 6 illustrates a light path set when micromirrors of the display apparatus according to the first embodiment of the present invention are in an ‘on’ state.

FIG. 7 illustrates a light path set when the micromirrors of the display apparatus according to the first embodiment of the present invention are in an ‘off’ state.

FIGS. 8 through 15 illustrate display apparatuses according to second to seventh embodiments of the present invention, respectively.

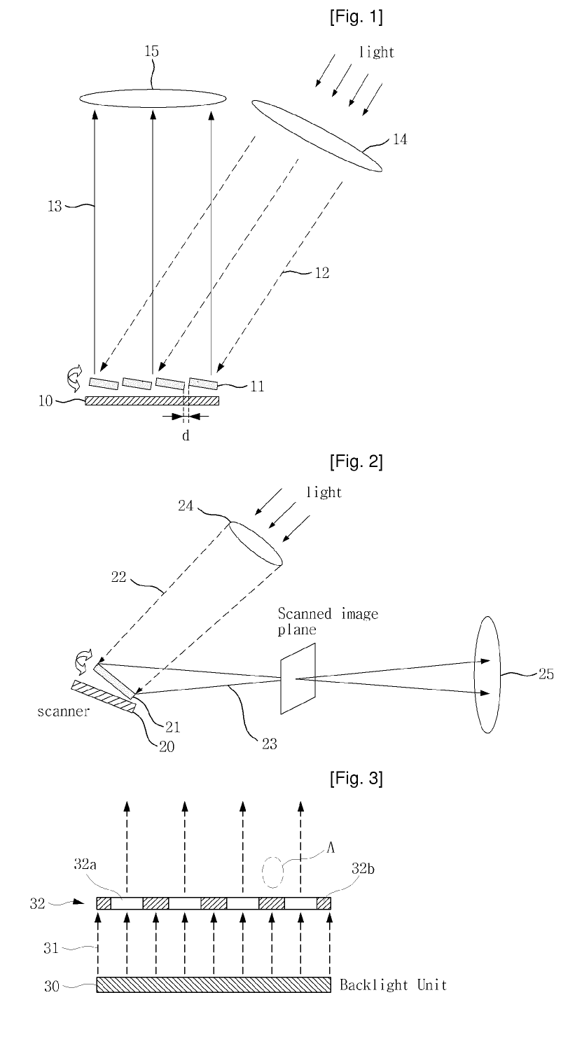

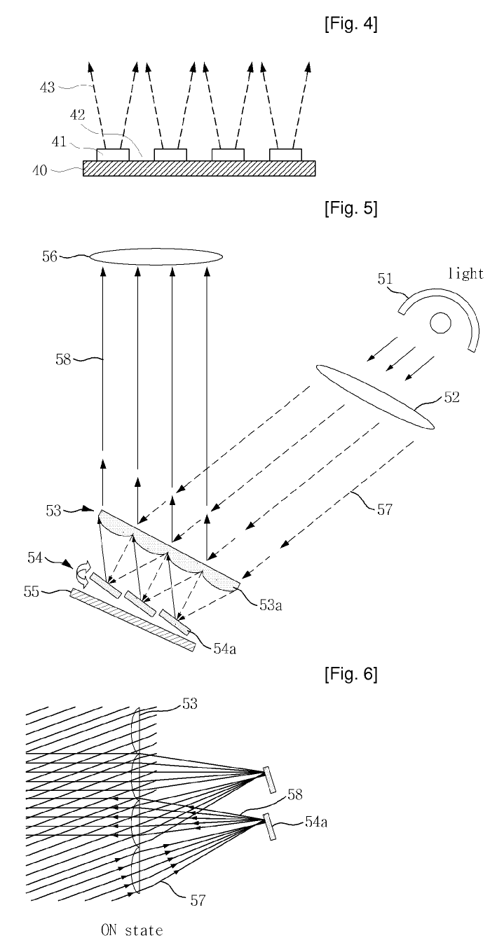

### BEST MODE FOR CARRYING OUT THE INVENTION

Hereinafter, various embodiments of the present invention will be described in detail with reference to the accompanying drawings.

### First Embodiment

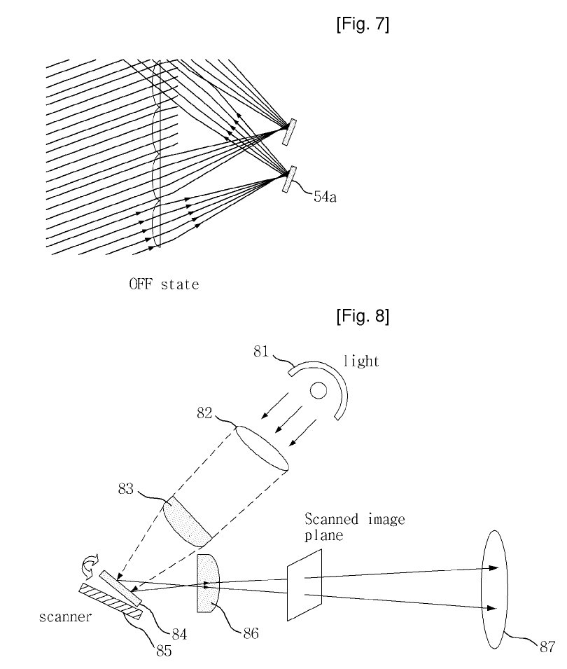

FIG. 5 illustrates a display apparatus according to a first embodiment of the present invention. FIG. 6 illustrates a light path set when micromirrors of the display apparatus according to the first embodiment of the present invention are in an ‘on’ state. FIG. 7 illustrates a light path set when the micromirrors of the display apparatus according to the first embodiment of the present invention are in an ‘off’ state.

Referring to FIG. 5, the display apparatus according to the first embodiment uses a reflective projection mode, and includes a light source 51 used to provide light, an incident lens 52, a microlens array 53, a micromirror array 54, a substrate 55, and a projection lens 56.

The incident lens 52 is disposed on an incident side of the display apparatus, and allows impingement of rays of light beamed from the light source 51 on a target. The projection lens 56 is disposed on an emission side of the display apparatus, and projects rays of reflected light 58 from the micromirror array 53.

The substrate 55 supports the micromirror array 54. Micromirrors 54a of the micromirror array 54 are arranged to be rotatable over the substrate 55, so as to reflect rays of incident light 57 from the incident lens 52 in different directions according to a rotational angle. Based on this rotational angle, the micromirror array 54 is divided into a bright state in which an image is displayed and a dark state in which an image is not displayed. Adjusting a sustaining time of the bright and dark states allows displaying of an image.

The microlens array 53 includes a plurality of microlenses 53a disposed between the incident lens 52 and the micromirror array 54. The microlens array 53 condenses the rays of the incident light 57 from the incident lens 52 upon the micromirror array 54, and condenses again the rays of the reflected light 58 from the micromirror array 54 upon a target as parallel light rays. In other words, one microlens array 53 changes traveling paths of the incident light 57 and the reflected light 58.

At this time, the microlenses 53a are arranged adjacent to each other to disallow generation of spaces between the microlenses 53a, and also arranged such that the rays of the incident light 57 passing through the microlenses 53a impinge respectively on reflection surfaces of the micromirrors 54a of the micromirror array 54.

Specifically, each of the microlenses 53a corresponds to one of the micromirrors 54a to condense the incident light 57, and to another micromirror to change the reflected light 58 from the other corresponding micromirror into parallel light. Although it is illustrated in FIG. 5 that the microlenses 53a each correspond to micromirrors each next to the selected microlens, the microlenses 53a may correspond respectively to adjacent micromirrors 54a depending on a reflection angle of each of the micromirrors 54a, and a position and distance thereof. Alternatively, each of the microlenses 53a may correspond to the individual micromirrors 54a allocated at certain positions.

In the display apparatus according to the first embodiment of the present invention, the rays of the incident light 57 transmitted through the incident lens 52 from the light source 51 are condensed upon the micromirror array 54 through the microlens array 53. The micromirror array 54 reflects the condensed light rays at a certain angle, and the reflected light rays pass again through the microlens array 53 to become parallel light rays. The projection lens 56 on the emission side projects the parallel light rays on a screen.

According to the first embodiment of the present invention, since the rays of the incident light 57 from the incident lens 52 are condensed upon and impinge on a reflection surface of the micromirror array 54 through the microlens array 53, the incident light 57 does not impinge on edge regions of the micromirror array 54 and between the micromirrors 54a. Also, the rays of the incident light 57 are condensed by each of the micromirrors 54a and reflected thereafter, and thus, elimination of a dark region in an image can be achieved.

Referring to FIG. 6, when the micromirror array 54 is in an ‘on’ state, the microlens array 53 focuses the rays of the incident light 57 on the reflection surfaces of the micromirrors 54a, and then, the micromirror array 54 reflects the focused rays of the incident light 57 since the micromirrors 54a each are rotated by a certain angle from the substrate 55. Rays of the reflected light 58 are directed towards the microlens array 53 and changed into parallel light rays.

On the contrary, as illustrated in FIG. 7, when the micromirror array 54 is in an ‘off’ state, the rays of the incident light 57 are focused on the reflection surfaces of the micromirrors 54a. However, since the micromirrors 54a are not rotated from the substrate 55, rays of the reflected light 58 from the micromirrors 54a are not directed towards the microlens array 53, and fall outside of an image display region.

In the case where the display apparatus according to the first embodiment of the present invention is applied to the conventional projection mode, one of the microlenses 53a and one of the micromirrors 54a are configured as a unit pixel. A period of time that transmits or shields light included in the unit pixel is adjusted through the individual micromirrors 54a, so as to display an image. At this time, an image corresponding to the unit pixel includes single-colored light. Because the image is displayed by adjusting the period of time for which the single-colored incident light is projected using the individual micromirrors 54a, the projected image does not change even if an image that is reflected through one of the micromirrors 54a is subjected to a left-right inversion.

### Mode for the Invention

### Second Embodiment

FIG. 8 illustrates a simplified view of a display apparatus according to a second embodiment of the present invention. Particularly, the illustrated display apparatus uses a scanning mode.

As illustrated, the display apparatus according to the second embodiment includes microlenses each disposed on incident and emission sides of light to change traveling paths of incident light impinging on a scanning micromirror 84 and reflected light from the scanning micromirror 84. More specifically, the display apparatus includes a light source 81, a first lens 82, a first microlens 83, the scanning micromirror 84, a substrate 85, a second microlens 86, and a second lens 87.

The first lens 82 is disposed on the incident side to allow rays of light beamed from the light source 81 to impinge on a target. The second lens 87 is disposed on the emission side to project rays of light from the second microlens 86 on a screen.

The scanning micromirror 84 are supported over the substrate 85, and disposed to be rotatable over the substrate 85 to reflect the incident light rays from the first lens 82. According to an operational angle of the scanning mirror 84, the reflected light rays are scanned at a fast speed on the screen. The scanned rays of the reflected light allow an image to be displayed on the screen.

The first microlens 82 is disposed between the first lens 82 and the scanning micromirror 84 to condense the incident light rays from the first lens 82 upon a reflection surface of the scanning micromirror 84. The second microlens 86 is disposed in a path of the light reflected from the scanning micromirror 84 (i.e., between the scanning micromirror 84 and the second lens 87). The second microlens 86 restores the path of the reflected light from the scanning micromirror 84 into the original light path.

In the display apparatus according to the second embodiment of the present invention, the first microlens 83 condenses the incident light rays passing through the first lens 82 from the light source 81 upon a small region of the reflection surface of the scanning micromirror 84, and the scanning micromirror 84 reflects the condensed light rays at a certain angle. The second microlens 86 restores the light path of the reflected light into the original light path. Afterwards, the second lens 87 projects rays of the reflected light whose light path is restored on a screen. If the scanning micromirror moves rapidly and consecutively, rays of beamed light are focused according to individual reflection angles, so that a two-dimensional scanning pattern such as a raster pattern is displayed. As a result, an image can be displayed.

The scanning type display apparatus according to the second embodiment beams light per unit pixel by moving one scanning micromirror 84 at a fast speed, and thus, the resolution of an image is determined by the operational speed of the scanning micromirror 84. That is, as the scanning speed of the scanning micromirror 84 increases, an image can be displayed with the higher resolution.

Therefore, with use of the first microlens 83 and the second microlens 86, rays of incident light impinging on the scanning micromirror 84 can be condensed upon a small region of the reflection surface of the scanning micromirror 84 by the first microlens 83. Hence, the size of the scanning micromirror 84 can be reduced. The reduced size of the scanning micromirror 84 allows the operational speed of the scanning micromirror 84 to increase. As a result, a high-resolution image can be displayed.

### Third Embodiment

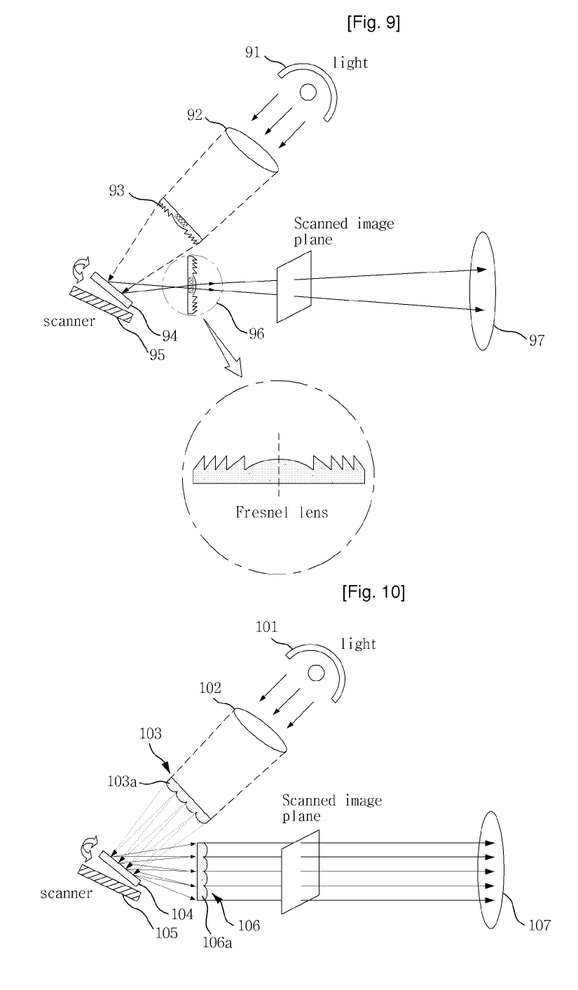

FIG. 9 illustrates a simplified view of a display apparatus according to a third embodiment of the present invention.

As similar to the display apparatus described in the second embodiment, the display apparatus according to the third embodiment uses the scanning mode. However, instead of the first microlens 83 and the second microlens 86 (See FIG. 8), two Fresnel lenses are used in the third embodiment.

The display apparatus according to the third embodiment includes a light source 91, a first lens 92, a first Fresnel lens 93, a scanning micromirror 94, a substrate 95, a second Fresnel lens 96, and a second lens 97.

Those elements having substantially the same functions and structures as described in the second embodiment will be omitted, and description about elements of the display apparatus different from those of the display apparatus described in the second embodiment will be provided. The first Fresnel lens 93 is disposed between the first lens 92 and the scanning micromirror 94, and condenses rays of incident light from the first lens 92 upon a small region of a reflection surface of the scanning micromirror 94. The second Fresnel lens 96 is disposed in a path of light reflected from the scanning micromirror 94 (i.e., between the scanning micromirror 94 and the second lens 97), and corrects the path of the reflected light from the scanning micromirror 94 to the original light path.

The first Fresnel lens 93 and the second Fresnel lens 96 each are generally divided with groups of several bands, and aberrations having a prism function are formed on the individual bands. As illustrated, a spherical surface is formed as a convex lens in a central portion of each of the first and second Fresnel lenses 93 and 93, and the aberrations are formed symmetrically on both sides of the central portion.

Therefore, the incident light rays passing through the first lens 92 are refracted by the aberrations, and condensed upon the small region of the scanning micromirror 94. The reflected light rays from the scanning micromirror 94 transmit the second Fresnel lens 96, and as a result, the light path of the reflected light can be corrected to the original light path.

As illustrated in FIG. 8, if one microlens is used as like the first microlens 83 and the second microlens 86, the size of the microlens needs to be adjusted according to the size of the screen or the micromirror. Thus, the lens becomes large and thick.

On the other hand, as described in the third embodiment, the thickness of the lens can be reduced due to the first and second Fresnel lenses 93 and 96. Specifically, the aberrations of the first and second Fresnel lenses 93 and 96 can be precisely adjusted, and thus, the display apparatus can be implemented with the scanning mode.

### Fourth Embodiment

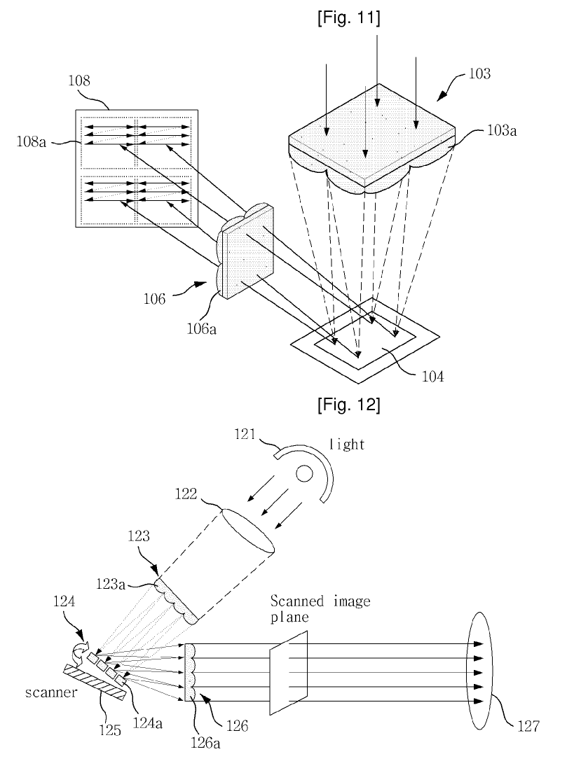

FIG. 10 illustrates a simplified view of a display apparatus according to a fourth embodiment of the present invention. FIG. 11 is a diagram illustrating the concept of realizing high resolution using the display apparatus according to the fourth embodiment of the present invention.

Referring to FIG. 10, as similar to the second embodiment described in FIG. 8, the display apparatus according to the fourth embodiment uses the scanning mode, and includes a plurality of microlenses.

The display apparatus according to the fourth embodiment includes a light source 101, a first lens 102, a first microlens array 103, a substrate 105, a scanning micromirror 104, a second microlens array 106, and a second lens 107. The first lens 102 is disposed on an incident side of light, and allows impingement of light beamed from the light source 101. The first microlens array 103 includes a plurality of microlenses 103a. The scanning micromirror 104 is disposed to be rotatable over the substrate 105. The second microlens array 106 includes a plurality of microlenses 106a. The second lens 107 is disposed on an emission side of the light, and projects the light reflected from the scanning micromirror 104 on a screen.

Those elements having substantially the same functions and structures as described in the second embodiment will be omitted, and description about elements of the display apparatus different from those of the display apparatus described in the second embodiment will be provided. The first microlens array 103 and the second microlens array 106 each are formed in the form of an array where the respective microlenses 103a and 106a are arranged. The first and second microlens arrays 103 and 106 along with the scanning micromirror 104 display an image.

The first and second microlens arrays 103 and 106 are used to prevent the enlargement and thickening of the lens usually observed when only one lens is used as described in the second embodiment. A certain arrangement of the microlenses 103a and 106a allows the reduction in size and thickness of the lens.

Therefore, in the display apparatus according to the fourth embodiment, the first microlens array 103 condenses the incident light rays passing through the first lens 102 from the light source 101 upon a small region of the reflection surface of the scanning micromirror 104, and the scanning micromirror 104 reflects the condensed light rays at a certain angle. The second microlens array 106 corrects the light path of the reflected light rays into the original light path. Afterwards, the second lens 107 projects the corrected light rays on a screen.

As illustrated in FIG. 11, when the incident light rays passing through the first lens 102 transmit the microlenses 103a of the first microlens array 103, the incident light rays are condensed upon the scanning micromirror 104 while being divided into numerous paths through the individual microlenses 103a. The condensed incident light rays are reflected through the scanning micromirror 104 and pass through the respective microlenses 106a of the second microlens array 106.

In other words, the light (or image) is projected on a screen 108 by being divided into several unit blocks 108a prepared as many as the microlenses 103a. Thus, a high-resolution image can be displayed even if the scanning micromirror 104 operates at a low speed.

In the fourth embodiment, the first and second microlens arrays 103 and 106 each are formed in a 2×2 array. However, this array form can be changed or modified without being limited to the above exemplified array form as occasion arises.

### Fifth Embodiment

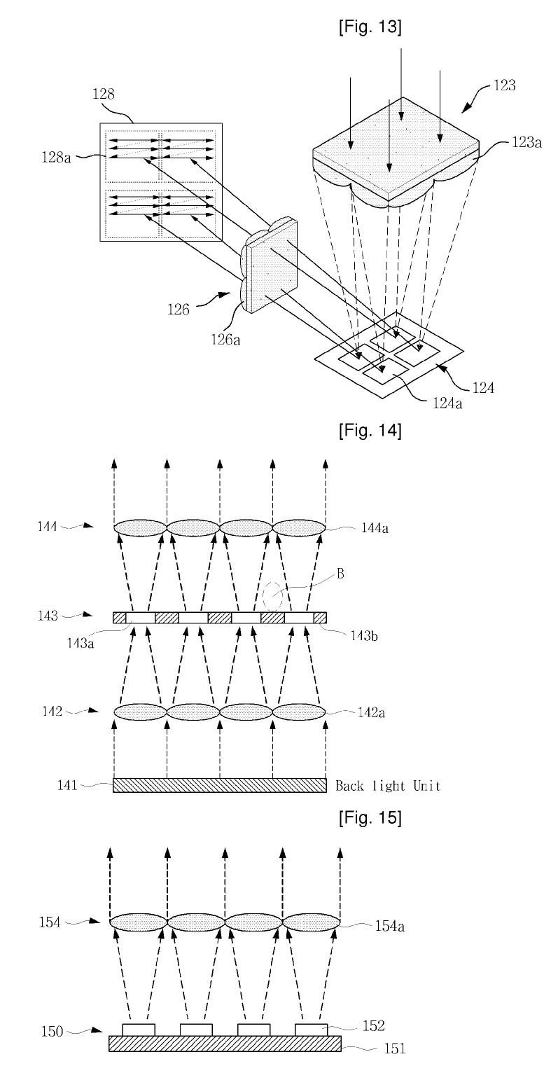

FIG. 12 illustrates a simplified view of a display apparatus according to a fifth embodiment of the present invention. FIG. 13 is a diagram illustrating the concept of realizing high resolution using the display apparatus according to the fifth embodiment of the present invention.

Referring to FIG. 12, the illustrated display apparatus is another exemplary display apparatus using the scanning mode, and includes a light source 121, a first lens 122, a first microlens array 123, a scanning micromirror array 124, a substrate 125, a second microlens array 126, and a second lens 127.

The first microlens array 123, the second microlens array 127, and the scanning micromirror array 124 include a plurality of microlenses 123a, microlenses 126a, and scanning micromirrors 124a, respectively, and are structured in an m×n array. The number of the microlenses 123a of the first microlens array 123 and the number of the microlenses 126a of the second microlens array 127 each are substantially the same as that of the scanning micromirrors 124a.

Therefore, a ray of incident light passing through one of the microlenses 123a of the first microlens array 123 is condensed upon a reflection surface of the corresponding scanning micromirror 124a, and a ray of light reflected from the scanning micromirror 124a passes through one of the microlenses 126a of the second microlens array 126 corresponding to the selected scanning micromirror 124a.

In the display apparatus according to the fifth embodiment of the present invention, the rays of light beamed from the light source 121 are projected on a screen 128 while being divided into several unit blocks 128a existing as many as the microlenses 123a. Thus, even if an operational speed of the scanning micromirror array 124 is small, a high-resolution image can be displayed. Also, since the size of the scanning micromirrors 124a can be reduced, the operational speed of the scanning micromirrors 124a can increase more than that of the scanning micromirror 104 (see FIG. 10) as described in the fourth embodiment of the present invention. Particularly, the higher the operational speed of the scanning micromirrors 124a, the higher the resolution of an image.

Those elements of the display apparatus according to the fifth embodiment that are substantially the same as the elements described in the second embodiment will not be described.

### Sixth Embodiment

FIG. 14 illustrates a simplified view of a display apparatus according to a sixth embodiment of the present invention. The display apparatus according to the sixth embodiment uses a liquid crystal display (LCD) that displays an image based on a mode of projecting or shielding light beamed from a light source.

The display apparatus according to the sixth embodiment includes a backlight unit 141, a liquid crystal panel 143, a first microlens array 142, and a second microlens array 144. The backlight unit 141 is disposed at the bottom side, and the liquid crystal panel 143 is disposed at the front side of the backlight unit 141. The first microlens array 142 is disposed between the backlight unit 141 and the liquid crystal panel 143, and the second microlens 144 is disposed at the front side of the liquid crystal panel 143.

The backlight unit 141 acts as a light source, and is generally disposed at the back side of the liquid crystal panel 143 to provide rays of light to the liquid crystal panel 143.

The liquid crystal panel 143 includes a plurality of unit pixels 143a, which are disposed between a top plate and a bottom plate and spaced apart from each other in a matrix form. Black matrixes 143b are formed between the unit pixels 143a to distinguish pixels or colors from each other. Therefore, an electric field with certain intensity is applied to the unit pixels 143a to change an arrangement of the liquid crystals composing the unit pixels 143a. As a result, a desired image can be displayed according to an amount of light projected upon the liquid crystal panel 143.

The first microlens array 142 is configured in an array of microlenses 142a, and condenses rays of incident light from the backlight unit 141 upon the individual unit pixels 143a of the liquid crystal panel 143.

The second microlens array 144 is configured in an array of microlenses 144a disposed in a path of light transmitted from the liquid crystal panel 143, and corrects a path of the light emitted from the unit pixels 143a to the original light path.

The microlenses 142a of the first microlens array 142 and the microlenses 144a of the second microlens array 144 individually correspond to the unit pixels 143a, and thus, an incident light ray passing through one of the microlenses 142a of the first microlens array 142 sequentially transmits one of the unit pixels 143a and one of the microlenses 144a of the second microlens array 144, both corresponding to the selected microlens 142a of the first microlens array 142.

In the display apparatus according to the sixth embodiment, the rays of light beamed from the backlight unit 141 pass through the first microlens array 142 corresponding to the individual unit pixels 143a of the liquid crystal panel 143, and are condensed small regions of the respective unit pixels 143a without the loss of light. The condensed light rays transmit the unit pixels 143a, and the second micromirror array 144 corrects the path of the condensed light rays to the original light path. As a result, the light (or image) can be projected on the entire screen. Accordingly, space regions ‘B’ between the unit pixels 143a in which an image is not displayed because of the isolation of the unit pixels 143a and the use of color filters can be eliminated, and this elimination allows an increase in brightness of an image and displaying of a soft image. In particular, since the light rays are condensed upon a target using the microlenses, the loss of light is less likely to occur, light usage efficiency can be improved, and the power consumption can be reduced. Hence, a high-quality image can be displayed.

### Seventh Embodiment

FIG. 15 illustrates a simplified view of a display apparatus according to a seventh embodiment of the present invention.

The display apparatus according to the seventh embodiment is an exemplary display apparatus that is self-luminous different from the projection type display apparatus or the LCD. Due to this self-luminescence, an unnecessary light source can be eliminated.

The display apparatus according to the seventh embodiment includes a substrate 151, a display panel 150 including a plurality of unit pixels 152 that emit light, and a microlens array 154 including a plurality of microlenses 154a arrayed in a path of light emitting from the display panel 150.

The display panel 150 has a structure that allows the unit pixels 152 to be spaced apart to a certain distance for the pixel isolation.

The microlenses 154a of the microlens array 154 are arrayed to correspond to the respective unit pixels 152 to correct the light path from each of the unit pixels 152. As a result of the light path correction, an image can be enlarged. At this time, the microlens array 154 can be applied to any structure pattern as long as the microlenses 154 are placed adjacent to each other as illustrated in FIG. 15, or have the lens size and spacing distance sufficient for most rays of the light emitted from the individual unit pixels 152 to impinge on the microlenses 154a even if the microlenses 154a are spacer apart.

Therefore, the display apparatus according to the seventh embodiment of the present invention can have an enlarged image due to the fact that the microlens array 154 corrects the path of the light emitted from the individual unit pixels 152 of the display panel 150. Since the light rays are not projected to the spaces between the unit pixels 152, dark space regions in which an image is not displayed can be eliminated. This elimination of the space regions allows an increase in brightness of an image and displaying of a soft image.

The display apparatus according to the seventh embodiment can be applied to organic light emitting diodes (OLEDs), plasma display panels (PDPs), field emission displays (FEDs), electroluminescent displays (ELDs), and luminescent diodes (LEDs) each using the self-luminous mode.

While the present invention has been described with respect to specific embodiments, it will be apparent to those skilled in the art that various changes and modifications may be made without departing from the spirit and scope of the invention as defined in the following claims.

1. A display apparatus using a microlens, the display apparatus comprising:
a micromirror array including a plurality of micromirrors arranged to reflect incident light rays from a light source;
a substrate supporting the micromirror array; and
a microlens array including a plurality of microlenses disposed between the light source and the micromirror array to condense the incident light rays from the light source upon the micromirror array and correct a traveling path of reflected light rays from the micromirror array.

2. The display apparatus of claim 1, wherein the micromirrors each are disposed to be rotatable over the substrate.

3. The display apparatus of claim 1, wherein the incident light rays passing through the microlens array are condensed upon reflection surfaces of the micromirrors.

4. The display apparatus of claim 1, wherein the microlenses of the microlens array are disposed adjacent to each other.

5. The display apparatus of claim 1, wherein the reflected light rays from the individual micromirrors impinge on one of the microlenses of the microlens array.

6. The display apparatus of claim 1, wherein the reflected light rays from the micromirror array are emitted after being corrected to parallel light rays by the microlens array.

7. A display apparatus using a microlens, the display apparatus comprising:
a scanning micromirror reflecting incident light rays from a light source;
a substrate supporting the scanning micromirror;
a first microlens disposed between the light source and the scanning micromirror to condense the incident light rays from the light source upon a reflection surface of the scanning micromirror; and
a second microlens disposed in a path of reflected light rays from the scanning micromirror to correct a traveling path of the reflected light rays.

8. The display apparatus of claim 7, wherein the scanning micromirror is disposed to be rotatable over the substrate.

9. The display apparatus of claim 7, wherein the first microlens and the second microlens each include an array of microlenses.

10. The display apparatus of claim 9, wherein the incident light rays are divided into unit blocks according to the number of the microlenses of the first microlens and directed towards the scanning micromirror.

11. The display apparatus of claim 7, wherein the first microlens and the second microlens each include an array of microlenses, and the scanning micromirror includes an array of scanning micromirrors.

12. The display apparatus of claim 11, wherein the incident light rays passing through the first microlens are divided into unit blocks according to the number of the microlenses of the first microlens, and the divided incident light rays are condensed upon the respective scanning micromirrors.

13. A display apparatus using a microlens, the display apparatus comprising:
a scanning micromirror reflecting incident light rays from a light source;
a substrate supporting the scanning micromirror;
a first Fresnel lens disposed between the light source and the scanning micromirror to condense the incident light rays from the light source upon a reflection surface of the scanning micromirror; and
a second Fresnel lens disposed in a path of reflected light rays from the scanning micromirror to correct a traveling path of the reflected light rays.

14. The display apparatus of claim 13, wherein the scanning micromirror is disposed to be rotatable over the substrate.

15. A display apparatus using a microlens, the display apparatus comprising:
a liquid crystal panel including a plurality of unit pixels arranged in a matrix form to display an image through transmitting or shielding incident light rays from a light source;
a first microlens array including a plurality of microlenses disposed between the light source and the liquid crystal panel to condense the incident light rays from the light source upon the unit pixels; and
a second microlens array including a plurality of microlenses disposed in a path of projected light rays from the liquid crystal panel to correct a traveling path of the projected light rays from the unit pixels.

16. The display apparatus of claim 15, wherein the unit pixels of the liquid crystal panel are spaced apart from each other for isolation of the unit pixels.

17. The display apparatus of claim 15, wherein the microlenses of each of the first an d second microlens arrays are disposed adjacent to each other.

18. A display apparatus using a microlens, the display apparatus comprising:
a display panel including a plurality of unit pixels emitting rays of light on a substrate; and
a microlens array including a plurality of microlenses formed in a path of the rays of the light emitted from the display panel to correct a traveling path of the emitted light rays.

19. The display apparatus of claim 18, wherein the unit pixels of the display panel are spaced apart from each other for isolation.

20. The display apparatus of claim 18, wherein the microlenses of the micromirror array are disposed adjacent to each other.
